(19) United States
(12) Patent Application Publication
(10) Pub. No.: US 2006/0016501 A1
(43) Pub. Date: Jan. 26, 2006

(54) Method for making plastic or metalloplastic flexible tubes

(76) Inventor: Jacques Benquet, Talant (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/532,002

(22) PCT Filed: Oct. 21, 2003
(86) PCT No.: PCT/FR03/03105

§ 371 Date: Jun. 2, 2005

(30) Foreign Application Priority Data
Oct. 25, 2002 (FR) 0213352

(51) Int. Cl. F16L 11/00

(52) U.S. Cl. 138/138

(57) ABSTRACT

The invention concerns a method for making flexible tube skirts comprising a step of making a cylindrical sleeve from a planar web including several plastic or metal layers followed by a step whereby said cylindrical sleeve is cut out to the desired length to obtain said skirts. It comprises a step prior to the step of making the cylindrical sleeve, wherein the web is subjected to a plastic deformation resulting in its being thinned by at least 0.5% or in producing a raised surface whereof the amplitude ranges at least between 1/30 and 5 times the thickness. The web is for instance passed through the air-gap between two substantially parallel rolls. Typically, the rolls exert on the web a force ranging between 2.5 and 500 newtons per millimetre of web width.

### TECHNICAL FIELD

The invention concerns the improvement of a method for making flexible tubes intended for storing and dispensing products in liquid to paste form. These flexible tubes are said to be “laminated” because they comprise a head and a flexible skirt, the latter obtained from a so-called “laminated” web generally comprising several plastic or metal layers. The skirt is obtained by cutting out a cylindrical sleeve, the latter obtained by rolling up a planar web. The web is rolled up so that it is shaped into a cylinder, the edges of said web are positioned facing one another, generally with a slight overlap, then welded together. Then a tube head is welded onto one end of said skirt. The head comprises a neck with an orifice for dispensing the product contained in the tube and a shoulder connecting the neck to said skirt. The tube so made is then delivered to the packer, head down and with the dispensing orifice blocked—for example with a cap screwed onto the neck—so that he is able to fill the tube through the end of the tube remaining open. Once the tube is filled, its open end is flattened so that a welding operation can be performed to join the opposite facing wall portions after flattening and thereby to seal the packed product (so-called transverse or final welding).

### PRIOR ART

Already known, for example with FR 1 571 778, is the conventional manufacture of cylindrical tubes by rolling up a web and then by heat welding the web edges, for example by induction, after they have been positioned facing each other. Hereinafter, we shall refer to cylindrical tubes formed in this way as “sleeves” to distinguish them from the flexible tubes intended for storing and dispensing products in liquid to paste form.

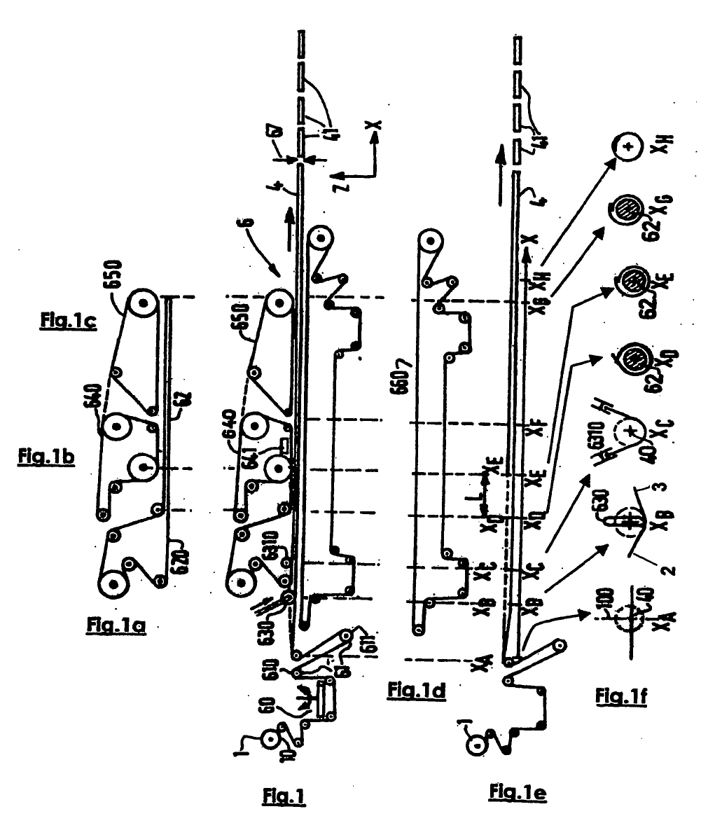

FIGS. 1 to 4 show a device implementing a typical prior art method that allows sleeves of this kind to be made.

FIG. 1 is a view, in longitudinal cross-section in the plane XZ or PXZ, of the device or production line (6) that allows a sleeve (4) to be made from a web (1) rolled up in the form of a spool. The sleeve is then cut to a pre-set length to obtain cylindrical skirts (41) intended to be assembled with heads to obtain flexible tubes.

In FIG. 1e, different means of the production line 6 have been marked along the longitudinal direction X by their abscissa X=XA to XF.

FIGS. 1a to 1d are cross-sectional views along the plane PXZ of the different moving strips (620, 640, 650 and 660) of the device (6) closed in on themselves, positioned one relative to the other along the axis X, but displaced along the axis Z in order to show them separately:

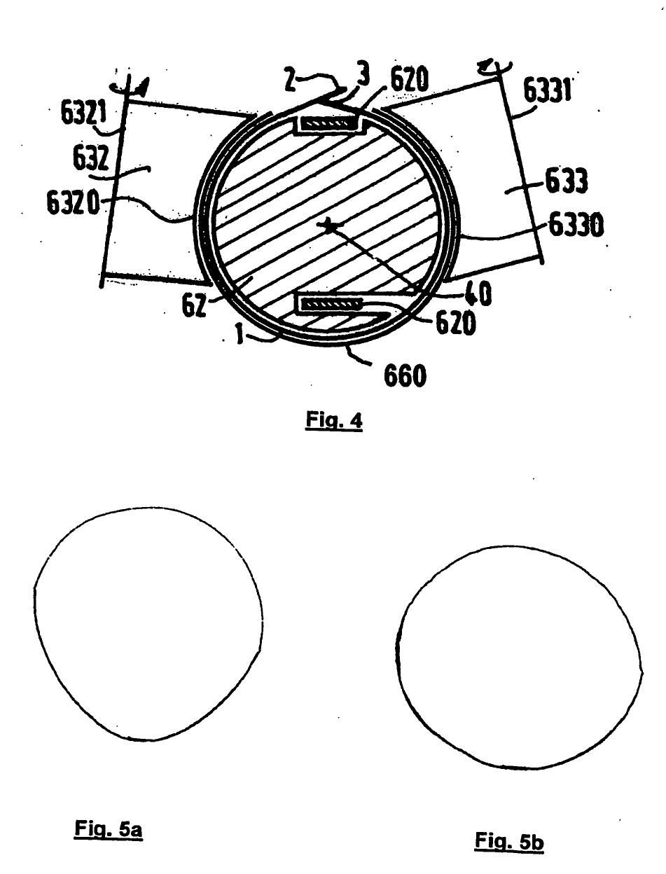

FIG. 1a: moving strip (620) integral with the central mandrel (62), the so-called “inner strip”, shown in cross-section in FIG. 4, located underneath the overlap zone of the edges 2 and 3 of the web, and which stretches from X=XD to X=XG, typically over a length of approximately 1.8 m.,

FIG. 1b: moving strip (640), the so-called “hot outer strip”, located over the overlap zone of the edges 2 and 3 of the web, which stretches from X=XE to X=XF, typically over a length of approximately 0.4 m.,

FIG. 1c: moving strip (650), the so-called “cold outer strip”, located over the overlap zone of the edges 2 and 3 of the web, which stretches from X=XF to X=XG, typically over a length of approximately 1 m.,

FIG. 1d: moving strip (660), the so-called conveyor strip, located underneath the rolled up web and the sleeve, which draws the tube over a length of some 2.5 m, between X=XB and X=XH.

FIG. 1e and FIG. 1f describe more particularly the web (1) in said production line (6) and the making of the sleeve by rolling up and welding the edges of said web (1). FIG. 1e shows the web and the sleeve in cross-section in the plane PXZ. FIG. 1f shows, in the form of transverse cross-sections along a plane YZ, in different abscissas, marked from XA to XH along the axis X, the successive steps of rolling up the web (1), overlapping the edges (2) and (3) of said web and welding said edges.

Hereinafter, in relation to FIG. 1, we shall indicate, from upstream to downstream, the different means present on the line (6), in addition to the different moving strips in FIGS. 1a to 1e, some of these means not being shown as such in FIG. 1 so as not to overload it:

a) upstream from X=XA, which represents the point on the line (6) where the web arrives plane and in the correct transverse position, in other words with its median plane (100) including the fixed longitudinal axis (40), are found firstly the means (10) for feeding in the web (1), typically a spool streamer, and then a lateral guide means (60),

then, as shown in a more detailed way in FIG. 3, two tension rollers (61), with one upstream tension roller (610) and one downstream tension roller (611), their different rotational speeds inducing a tension in the web that is intended to stabilise its edges or rims by eliminating lateral undulations where they exist. FIG. 3 is a diagrammatic view of a device (61) including two tension rollers (610) and (611), wherein either, since both rollers are of the same diameter as shown in FIG. 3, the second roller (611) rotates at an angular velocity ω2 greater than the ω1 of the first roller (610), or, since the angular velocities are similar, the second roller (611) has a diameter greater than that of the first roller (610), so that the linear velocity of the web (1) is higher at the output of the second roller than at that of the first roller. Because of this, the web (1) is subjected between these two rollers to a longitudinal tension that is able to reach the yield strength of the material constituting the web.

The web (1) has been shown, upstream from the roller (610), with unevenness or undulations on the edges, whereas, after the web has been tensioned, downstream from the roller (611), the web has no uneven edges. This tension, typically of between 0.3 and 0.8 times the yield strength of the material forming the web (1), is maintained during the formation of the tube (4).

b) between X=XA and X=XB, are generally found additional means allowing the positioning of the web along the axis Y to be better controlled. Indeed, proper control of the transverse position of the web is important if even longitudinal welding is required to be obtained since it is necessary to control the geometrical configuration of the web edges when they are welded.

c) at the point X=XB, a central roller (630) is applied to the web (1) in its median plane (100), to begin rolling this web along a transverse profile shown in FIG. 1f.

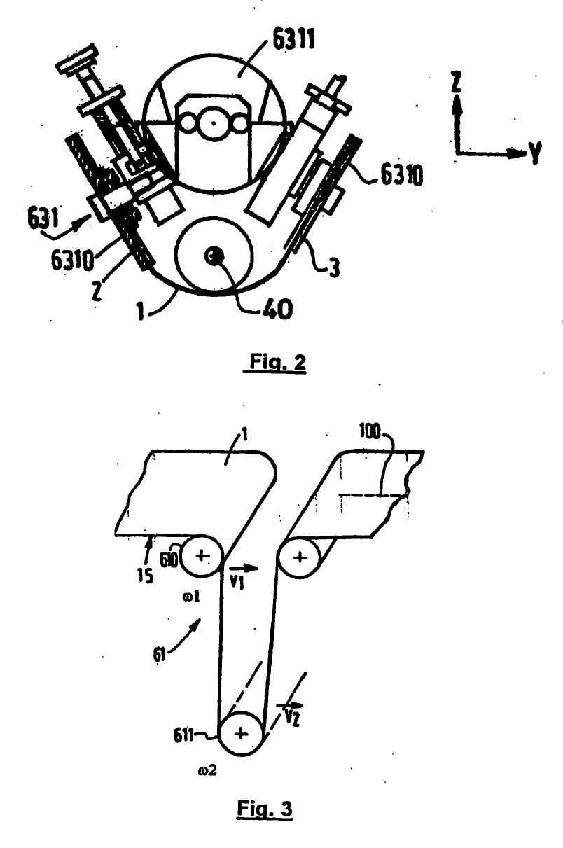

d) at the point X=XC, the edges (2) and (3) of the web are engaged in the grooves of the grooved rollers (6310), the web then having a transverse profile shown in FIG. 1f. FIG. 2 shows, in cross-section in a plane PYZ, a device (631) for guiding the edges (2, 3) of the web (1), using two grooved rollers (6310), the edges being held in the grooves, this device (631) including a circular support (6311) itself anchored to the frame of the line (6).

e) between X=XC and X=XD, are found in particular means (not shown in FIG. 1) for holding the central mandrel (62) in position and possibly for continuing the rolling of the web.

f) between X=XD and X=XE rollers (632) and (633) are applied laterally, as shown in FIG. 4, to overlay the edges (2, 3) of the web. FIG. 4 shows, with a cross-section in a plane PYZ, the web 1 being rolled up using the rollers (632) and (633), these rollers have a concave surface (6320) and (6330) and an axis of rotation (6321) and (6331) respectively, so as to position the upper (2) and lower (3) edges facing each other so they can be welded together. The axes (6321) and (6331) may be vertical or inclined—as is shown in FIG. 4—their point of convergence located on the same side as the overlap zone, to hold more firmly the edges 2 and 3 that face one another and to obtain the most stable overlap geometry possible. Indeed, it is essential for the geometric configuration of the web edges to be as stable as possible when they are welded. In particular, it is this which determines the overlap width, and consequently the width of the visible welding.

g) between X=XE and X=XF, the edges are held superposed one over the other (or simply juxtaposed one next to the other, as in the method described in EP 0 627 982 (Karl Mägerle Lizenz)) by means of pressure exerted by the hot outer strip (640) on the inner strip (620). Under the effect of this pressure, these edges are welded to each other by applying heat at this level, either just prior to entry into the zone X=XE to XF, or in the zone X=XE to XF itself, for example by means of an inductor (641) which acts directly on the web when this is metalloplastic.

h) between X=XF and X=XG, the weld is cooled while the sleeve is inwardly supported by the central mandrel (62). The weld zone is itself kept compressed between the moving inner strip (620) and the cold outer strip (650) throughout this run.

i) between XG and XH, the cylindrical sleeve so obtained emerges from its shaping device (the moving strips 620 and 650 and the central mandrel (62)) and is then cut (67) to the required length into cylindrical skirts (41).

### PROBLEM POSED

Despite all the precautions taken to control the lateral positioning of the web, the geometric configuration of the web edges when they are welded is not as stable as required and the quality of the weld suffers the consequences. And if visible defects on one and the same skirt may be avoided, the width of the longitudinal weld may vary considerably from one skirt to another and so it becomes difficult and costly to control the solidity of the weld. Since the phenomenon gets worse with the displacement velocity of the web, method productivity is thereby reduced.

In addition, as it emerges from its shaping device (the strips 620 and 650 and the central mandrel (62)), it can be seen that, in a great number of cases, particularly when the original web comprises more than 70% by volume of thermoplastic material, the sleeve loses its perfectly circular shape. Indeed, its cross-section takes on a “water drop” shape as is shown in the example presented below. This is particularly prejudicial to the subsequent operations conducted in order to make the flexible tube. In the first place, when assembling the tube head on one end of the skirt, it makes a bad fit with the circular end of the moulded head. Then, the other end of the skirt is a further source of problems since the packer has to fill the flexible tube by inserting a nozzle through this open end of the skirt. If this open end is not perfectly circular, the automatic insertion of the filling nozzle may be disrupted (with the end of the skirt getting stuck on the filling nozzle for example), which compels the addition of costly centring and calibrating means in order to attain the required filling rates. Lastly, when the tube is full, this same end is subjected to a final welding, which is greatly facilitated if the end of the skirt has a repetitive circular geometry.

The applicant has therefore sought to modify said manufacturing method in order to avoid these drawbacks.

### SUBJECT OF THE INVENTION

The subject matter of the invention is an improvement in the method for making flexible laminated tubes as previously described which consists in introducing a step prior to the step of making the web previously described. Prior to it being shaped into a cylinder by overlaying its two longitudinal edges and positioning them facing each other or juxtaposing them, stresses are applied onto the web such that it is subjected to an irreversible deformation once these stresses are released. This irreversible, or plastic, deformation is not necessarily very significant but is typically greater than 1%. What is important is that this plastic deformation affects enough of the thickness of the web to modify its state of residual stress.

To deform the web plastically, it may be thinned, for example by rolling, by at least 0.5%, preferably more than 1%. It may also be embossed resulting in the creation of raised surfaces or depths whereof the amplitude ranges between 1/30 and 5 times the thickness value, preferably between 1/15 and 5 times the thickness, but preferably between 1/10 and 3 times the thickness.

According to one preferred embodiment of the invention, the web is passed through the air-gap between two substantially parallel rolls, the median distance between the two rolls being less than the initial thickness of the web. Typically, these rolls have to exert on the web a force of between 2.5 and 500 newtons per millimetre of web width.

In some ways, this is simplified calendering, wherein the device used comprises a small number of rolls (restricted to two for example) and wherein said rolls are not necessarily heated. Hereinafter, we shall refer to this operation as “calendering” or, when the term is appropriate, “embossing”.

The force required depends on the nature of the material or materials constituting the web. When this comprises more than 70% thermoplastic material by volume, this force reduces with the average temperature of the web and increases with the viscous behaviour of the thermoplastic material.

The rolls may be smooth in which case calendering is applied which results in plastic thinning at least equal to 0.5% preferably more than 1%. The rolls may also include raised surfaces that are more or less marked, which allow the web to be embossed. The amplitude of the embossed raised surface is typically in a range between one thirtieth and five times the thickness of the web but the best results are obtained with raised surfaces of between 1/10 and 3 times the thickness. In this case, the force that has to be applied between the rolls is at least equal to the minimum force required to emboss the web.

Preferably, if the embossed raised surface does not cover the whole surface of the web, it has to be distributed evenly so as to be able to roll the web up in the form of an even spool. If the embossed decoration is not distributed evenly, it is then preferable to apply the embossing directly to the skirt manufacturing line, placing the rolls upstream of the device that allows the web to be shaped into a cylinder, for example upstream of the central roller (630) or, better, upstream of the lateral guide means of the web (60). Where the raised surface is distributed evenly over the whole width of the web, the effect of the embossing on the capacity of the web to shaped into a cylinder is so pronounced that said lateral guide means of the web may, in some cases, be regarded as superfluous.

If the web has a predominant plastic mechanical behaviour (capacity for bending irreversibly out of shape under slight tension), for example if it comprises more than 30% by volume of a metal such as an aluminium alloy, it may be laminated, or embossed at ambient temperature. It is laminated by being pressed between rolls such that the yield strength at the ambient temperature of said metal is reached: roughly, since the deformation is close to a plane deformation, the pressing force between rolls has to result, in the absence of tensile force, in a normal stress around 2/√3 times the yield strength. Embossing is carried out by applying sufficient force for the raised surfaces to be obtained irreversibly.

If the web comprises a great quantity of thermoplastic material, typically more than 70% by volume, it is then preferable to provide upstream of the entry of the web into the air-gap between the rolls a heating zone that is sufficiently long for the average temperature in the thickness of the web to reach a temperature of between 75 and 120° C. and to be kept at the required temperature for at least 0.5 seconds, just before coming into contact with the rolls.

The web which comprises a great quantity of thermoplastic material can also include layers constituted by non-thermoplastic materials, such as paper, metal or even heterogeneous layers for example of non-fabric materials constituted by heat compressed fibres. It can also comprise layers of thermoplastic material loaded with solid particles, typically calcium carbonate, clay, mica, etc. However, it has to comprise at least 70% of thermoplastic material by volume for the beneficial effect of the heat treatment previously recommended according to a preferred embodiment of the invention to be perceptible.

If passing between the rollers results in embossing, one of the rollers is preferably metal, the other of elastomer or rubber material. Preferably also, the metal roller is cooled so that its temperature is close to the ambient temperature, typically below 40° C., when the web, once it has emerged from the air-gap between the rolls, is either rolled around a winder, or deformed in order to be shaped into a cylinder.

Generally speaking, the flexible tube skirt comprises an imprinted decoration intended to inform the user about the product contained in the tube. In the present method for making flexible tubes, the decoration is imprinted on the web before it is shaped into a cylinder, for example before or while the web passes through the air-gap between the rolls.

In this case, the rolls can equate to the rolls employed to imprint the decoration, by flexography or direct typography for example. In cases where it is required to emboss the web, the etched roller enabling embossing can also be used to ink the embossed depths, which provides particular decorative (“print valley”) effects.

With this previous step, the web has a mechanical behaviour such that its capacity for being shaped into a cylinder is greatly improved and that the sleeve obtained no longer has a water drop shaped cross-section (it then has greater circularity) when it emerges from its shaping device (inner strip (620), cold outer strip (650) and central mandrel (62)). The greater capacity of the web for being shaped into a cylinder is due to the less frequent occurrence of lateral undulations on the edges of said web and to an elastic rigidity of said web that is more significant in the longitudinal direction and more homogeneous in the transverse direction.

Indeed, the previous step according to the invention is a calendering/embossing operation the effect of which is to control the shape of the web (fewer lateral undulations) and to reduce the amplitude of the residual stresses prevailing in said web. The effect of this is to make the stiffness of the web uniform and, above all when it comes to embossing which creates evenly distributed raised surfaces and/or depths, to increase the rigidity of the web, both in the longitudinal direction and in the transverse direction.

In this way, under the effect of bending forces, the web has a radius of curvature which is more homogeneous throughout its width. In addition, since these bending forces are locally imposed (by the central roller (630), by the means that allow the rolling of the web between X=XC and X=XD to be pursued, by rollers (632) and 633), the web, more rigid in the longitudinal direction, better retains the shape imposed outside the zone of application of said forces. All this allows the edges of the web to be guided better during the rolling until they are positioned facing each other (or juxtaposed) so they can be welded together. An overlap geometry is then obtained which is more stable and the welding carried out is of better quality.

Lastly, uniform stiffness in the transverse direction and reduced residual stresses are a possible explanation for the fact that the sleeve has better circularity after it exits from the shaping device.

### FIGURES

As we have already seen, FIGS. 1 to 4 show a device able to shape a web into a cylindrical sleeve. FIG. 5 shows two sleeve cross-sections. FIG. 5a shows a water drop shaped cross-section, relating to a sleeve which has not been subjected to the previous treatment according to the invention. FIG. 5b relates to a sleeve which has been subjected to said treatment: it presents better circularity.

### EXAMPLES

### Example 1

A metalloplastic web with an overall thickness of 280 μm, with a width of 225 mm, has the following structure:

PE.BD (90 μm)/EAA (25 μm)/aluminium (15 μm)/EAA (20 μm)/PE.BD (130 μm)

with PE.BD=low-density polyethylene

EAA=copolymer (ethylene acrylic acid)

The web is presented in as a spool. A first part of the web is used without being subjected to the previous treatment according to the invention. It is used to make a cylindrical sleeve as has previously been described and shown in FIGS. 1 to 4. Its displacement velocity is of the order of 30 m/min.

After winding the whole spool, that is some 1000 m, it can be seen that the sleeve emerges with a longitudinal weld of variable width varying between 1.6 and 2.5 mm. Its cross-section emerges from the shaping device with a water drop shape of the type similar to the one shown in FIG. 5a. The ovality (out-of-roundness) is measured by comparing the values of two orthogonal diameters L and P, with the axis L selected to correspond to the maximum diameter. In the left-hand part of table 1, it can be seen that the mean of the relation between these diameters is 0.95, with a standard deviation of 0.02.

Another part of the same web is subjected to embossing at ambient temperature prior to being shaped into a cylinder. The embossing device includes an embossing roll etched with raised surfaces ranging between 50 and 100 μm in height and an elastomer support roll. The force applied on the embossing roll is of the order of 200 kN.

As in the blank test previously described, the web is displaced at a velocity of the order of 30 m/min. After embossing, the web, which has over its entire width the appearance of “leather”, is rolled up to form a spool.

Afterwards, the spool is used to make a cylindrical sleeve in accordance with the method previously described. It can be seen that the welding carried out is of greater quality than when the web is not embossed; its width varies but the amplitude of variation is clearly smaller: between 1.8 and 2.2 mm. Its cross-section emerges from the shaping device with a circular shape of the type similar to that shown in FIG. 5b. In the right-hand part of table 1, it can be seen that the mean diameter ratio of is 0.99, with a standard deviation of 0.02.

TABLE 1

| | OUT-OF-ROUNDNESS MEASUREMENTS | | | | | |
|---|---|---|---|---|---|---|
| | Unembossed tubes | | | Embossed tubes | | |
| | Diameter | Diameter | | Diameter | Diameter | |
| | measured | measured | | measured | measured | |
| | along | along | P/L | along | along | P/L |
| | axis L | axis P | ratio | axis L | axis P | ratio |
| Mean | 36.45 | 34.55 | 0.95 | 35.5 | 35 | 0.99 |
| Standard | 0.36 | 0.36 | 0.02 | 0.46 | 0.26 | 0.02 |
| deviation | | | | | | |

On the other hand, an improvement can be seen in the so-called “rebound” properties. The “rebound” is characteristic of the capacity of the tube skirt to return to its cylindrical shape after it has been pressed. The higher this value is, the better this capacity is. It is measured with standardised bending tests using the support sheet method: a half skirt is cut along a diametric plane and is embedded by its ends to a support. The arch so formed is driven by using an axial device which comes in contact onto the generating line at the top of the arch (MD). Other tests have been carried out on an arch formed with the half-skirt curved in a direction perpendicular to the axial direction (CMD). The value of the driving-in force equating to a pre-set deflection was measured. Table 2 below shows the value of the force (in N) equating to a deflection of 5 mm in respect of a skirt with a diameter of 35 mm.

TABLE 2
REBOUND MEASUREMENTS

| | |
|---|---|
| Unembossed tubes | Embossed tubes |

| | | | |
|---|---|---|---|
| MD | 1.1 | MD | 1.6 |
| CMD | 1.0 | CMD | 1.4 |

### Example 2

A web completely of plastic with an overall thickness of 280 μm, with a width of 225 mm, has the following structure:

PE.BD (15 μm)/PEHD (60 μm)/PE.BD (75 μm)/EMA (10 μm)/EVOH (20 μm)/EMA (10 μm)/PE.BD (90 μm)

with PE.BD=low-density polyethylene

PE.HD=high-density polyethylene

EAA=copolymer (ethylene acrylic acid)

The web is presented as a spool. A first part of the web is used without being subjected to the previous treatment according to the invention. It is used to make a cylindrical sleeve as has previously been described and shown in FIGS. 1 to 4.

After winding the whole spool (some 1000 m), it can be seen that the sleeve emerges with a longitudinal weld of variable width varying between 1.4 and 2.6 mm. Its cross-section emerges from the shaping device with a water drop shape of the type similar to the one shown in FIG. 5a. The ovality is measured by comparing the values of two orthogonal diameters L and P, with the axis L selected to correspond to the maximum diameter. In the left-hand part of table 3, it can be seen that the mean diameter ratio is 0.93, with a standard deviation of 0.02.

TABLE 3

| | OUT-OF-ROUNDNESS MEASUREMENTS | | | | | |
|---|---|---|---|---|---|---|
| | Unembossed tubes | | | Embossed tubes | | |
| | Diameter | Diameter | | Diameter | Diameter | |
| | measured | measured | | measured | measured | |
| | along | along | P/L | along | along | P/L |
| | axis L | axis P | ratio | axis L | axis P | ratio |
| Mean | 36.65 | 34.15 | 0.93 | 35.45 | 35.05 | 0.99 |
| Standard | 0.41 | 0.41 | 0.02 | 0.50 | 0.28 | 0.02 |
| deviation | | | | | | |

Another part of the same web is subjected prior to being shaped into a cylinder to embossing intended to give it a “honeycomb” raised surface with concave hexagonal patterns of a depth substantially equal to 70 μm. Upstream of the embossing device, the web is displaced in a heating tunnel. It is taken up to a temperature of 80° C. and kept there for at least 0.6 seconds prior to entering the air-gap of the embossing device. The embossing device includes an etched embossing roll and an elastomer support roll. The force applied on the embossing roll is of the order of 170 kN.

The metal embossing roll is cooled with a water system. In this way, the web reaches the winder at a temperature close to the ambient temperature, in any case below 40° C.

The spool is then used to make a cylindrical sleeve. It can be seen that the weld made is of better quality; its width varies between 1.8 and 2.2 mm. Its cross-section emerges from the shaping device with a circular shape.

On the other hand, an improvement can be seen in the so-called “rebound” properties (see description in example 1). Table 4 below shows the value of the force (in N) equating to a deflection of 5 mm in respect of a skirt of 35 mm diameter.

REBOUND MEASUREMENTS

| | |
|---|---|
| Unembossed tubes | Embossed tubes |

| | | | |
|---|---|---|---|
| MD | 1.7 | MD | 2.4 |
| CMD | 1.4 | CMD | 2.4 |

1. Method for making flexible tube skirts including a step of making a cylindrical sleeve from a planar web including one or more plastic or metal layers followed by a step wherein said cylindrical sleeve is cut out to the required length to obtain said skirts, characterised in that it includes a step prior to the step of making the cylindrical sleeve, wherein said web is subjected to a plastic deformation.

2. Method according to claim 1 wherein said web is passed between two tools moving one relative to the other and the space between which offers said web an air-gap of a dimension less than the initial thickness of the web.

3. Method according to claim 2 wherein a force is applied between said tools in such a way that the web emerges from said air-gap thinned plastically by more than 0.5%, preferably more than 1%.

4. Method according to claim 2 wherein a force is applied between said tools in such a way that the web emerging from said air-gap has an embossed decoration including raised surfaces or depths whereof the amplitude ranges between one thirtieth and five times the thickness of said web, preferably between one fifteenth and five times the thickness, preferably again between one tenth and 3 times the thickness.

5. Method according to wherein said moving tools are substantially parallel rolls, at least one of which has etched raised surfaces, so that the web emerges embossed after passing between said rolls.

6. Method according to claim 2 wherein the web is compressed between said tools with a force of between 2.5 and 500 newtons per millimetre of web width.

7. Method according to claim 1 wherein said web is raised to a temperature of between 75° C. and 120° C. before coming into contact with said tools.

8. Method according to claim 7 wherein said web is kept at said temperature for at least a ½ second before coming into contact with said rolls.

9. Method according to claim 5 wherein at least one roll is cooled such that its temperature is close to the ambient temperature, typically below 40° C., when the web, once it has emerged from the air-gap between the rolls, is either wound around a winder, or deformed with a view to shaping it into cylinder.

10. Method according to claim 5 wherein the etched roll is also used to imprint a decoration onto said web.
